(19) United States
(12) Patent Application Publication
(10) Pub. No.: US 2009/0134619 A1
(43) Pub. Date: May 28, 2009

(54) Pipe fitting with tabs

(76) Inventor: Jon Houghton, Rochester Hills, MI (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/323,782

(22) Filed: Nov. 26, 2008

Related U.S. Application Data
(60) Provisional application No. 60/990,146, filed on Nov. 26, 2007.

(51) Int. Cl. F16L 55/00

(52) U.S. Cl. 285/39

(57) ABSTRACT

A pipe fitting or pipe having a body and at least one radially outward projecting projection disposed on a exterior surface of the pipe fitting. The projection may have a leverage point configured such that force applied to the leverage point is translated into a force on the pipe fitting. A method of installing the pipe fitting is also disclosed, including a preparation step, a first coupling step, and, optionally, a second coupling step. In the first coupling step, a force may be applied to one of the projections on the pipe fitting to manipulate the pipe fitting to operably couple it with a pipe. In the optional second coupling step, a force may be applied to one of the projections on the pipe fitting to brace the pipe fitting to operably couple it with a pipe. An installation tool may be used to apply a force to the projection.

This patent application is related to and claims priority to U.S. Provisional Application No. 60/990,146, filed on Nov. 26, 2007, entitled “Pipe with Tabs.” The disclosure of this priority application is hereby incorporated herein by reference in its entirety.

### FIELD OF INVENTION

This invention relates generally to pipe fittings and/or pipes. More particularly, it relates to tabs attached to pipe fittings to provide leverage points to facilitate assembly.

### BACKGROUND INFORMATION

Traditional methods for assembling pipes with fittings, one of which is commonly referred to as a bar-and-block method, involved a bracing device that was pushed against the pipe and/or fitting with a pry bar to provide the necessary leverage to assemble the pipe and/or fittings. This method for assembling pipes or fittings was, and continues to be, cumbersome and difficult to use. Moreover, the bar-and-block method cannot be effectively used on angled pipes or fittings, or gasketed fittings. These pipes and fittings are often hammered or forced onto pipes, often leading to damaged or broken pipes or fittings.

### SUMMARY

An exemplary embodiment may provide an apparatus. The apparatus may be a pipe fitting with a first end, a second end and a body extending therebetween, and a projection extending radially outward from an exterior surface of the pipe fitting. The projection may have a first leverage portion whereby application of a first applied force to the first leverage portion results in a first translated force on the pipe fitting.

In accordance with another exemplary embodiment, a method of installing a pipe fitting may be provided. The method may include the step of providing a pipe fitting having at least a first end, a second end, a body, and at least one radially extending projection with a leverage point. The method may also include the step of providing a first pipe. The method may also include the step of applying a force to the leverage point of the projection, resulting in a force on the pipe fitting in the direction of the first end. The method may also include the step of operably coupling the first end of the pipe fitting with the first pipe.

### BRIEF DESCRIPTION OF THE DRAWINGS

Purposes and advantages of the exemplary embodiments will be apparent to those of ordinary skill in the art from the following detailed description in conjunction with the appended drawings in which like reference characters are used to indicate like elements, and in which:

FIG. 1A shows a perspective view of a pipe fitting with tabs according to an exemplary embodiment.

FIG. 1B shows a side view of a pipe fitting with tabs according to an exemplary embodiment.

FIG. 1C shows a top view of a pipe fitting with tabs according to an exemplary embodiment.

FIG. 1D show a perspective view of a pipe fitting with different ends with a tab according to an exemplary embodiment.

FIG. 1E show a side view of a tab for a pipe fitting in accordance with an exemplary embodiment.

FIG. 1F shows a cross section of a tab for a pipe fitting in accordance with an exemplary embodiment.

FIG. 2A shows a perspective view of a pipe fitting with tabs according to an exemplary embodiment.

FIG. 2B shows a side view of a pipe fitting with tabs according to an exemplary embodiment.

FIG. 2C shows a top view of a pipe fitting with tabs according to an exemplary embodiment.

FIG. 3A shows a perspective view of a pipe fitting with tabs according to an exemplary embodiment.

FIG. 3B shows a side view of a pipe fitting with tabs according to an exemplary embodiment.

FIG. 3C shows a top view of a pipe fitting with tabs according to an exemplary embodiment.

FIG. 4A shows a method of using of a pipe fitting with tabs according to an exemplary embodiment.

FIG. 4B shows a method of using of a pipe fitting with tabs according to an exemplary embodiment.

FIG. 4C shows a method of using of a pipe fitting with tabs according to an exemplary embodiment.

FIG. 4D shows a method of using of a pipe fitting with tabs according to an exemplary embodiment.

FIG. 4E shows a method of using of a pipe fitting with tabs according to an exemplary embodiment.

FIG. 5A shows a method of using of a pipe fitting with tabs according to an exemplary embodiment.

FIG. 5B shows a method of using of a pipe fitting with tabs according to an exemplary embodiment.

FIG. 5C shows a method of using of a pipe fitting with tabs according to an exemplary embodiment.

FIG. 5D shows a method of using of a pipe fitting with tabs according to an exemplary embodiment.

FIG. 5E shows a method of using of a pipe fitting with tabs according to an exemplary embodiment.

These and other embodiments and advantages will become apparent from the following detailed description, taken in conjunction with the accompanying drawings, illustrating by way of example the principles of the various exemplary embodiments.

### DETAILED DESCRIPTION OF PREFERRED EMBODIMENTS

It will be readily understood by those persons skilled in the art that the embodiments of the inventions are susceptible to broad utility and application. Many embodiments and adaptations of the embodiments of the inventions other than those herein described, as well as many variations, modifications and equivalent arrangements, will be apparent from or reasonably suggested by the embodiments of the inventions and foregoing description thereof, without departing from the substance or scope of the invention.

Generally speaking, the pipes or pipe fittings of the various exemplary embodiments described herein have one or more projections or tabs extending radially from the outer surface of the respective pipe or pipe fitting. The tabs may provide leverage points to assist a user in assembling pipe systems.

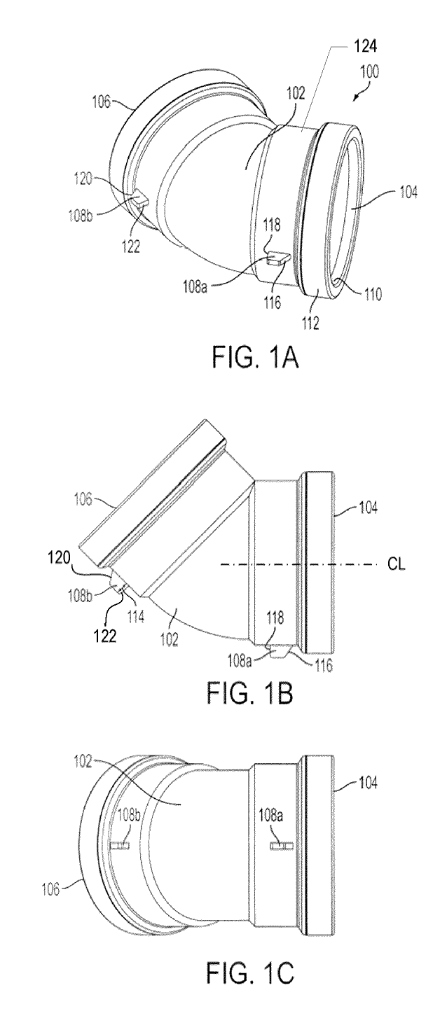

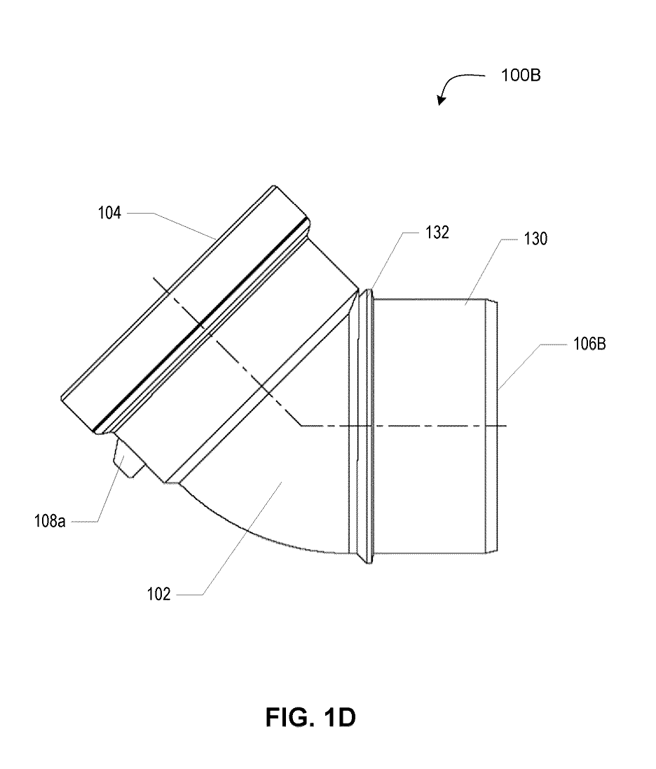

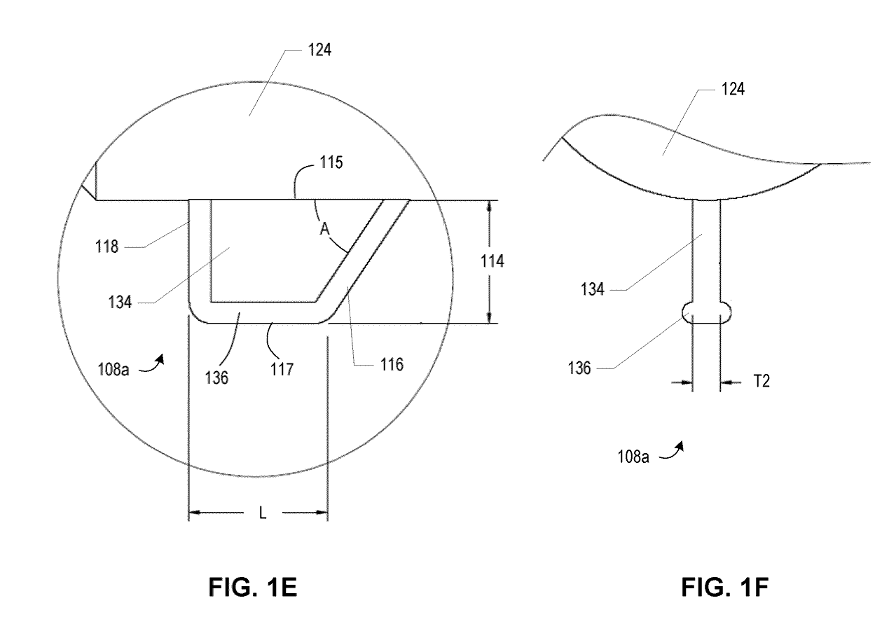

Exemplary embodiments and their advantages may be understood by referring to FIGS. 1A-5E, wherein like reference numerals refer to like elements. The various exemplary embodiments are generally described throughout this description in reference to a pipe fitting. However, the embodiments are not so limited. It is understood that the various features and embodiments of the invention may be appropriate for various components of a piping system, including, for example, pipes, tubes, connectors, caps, and other like devices.

It will be understood that the pipe fittings of the exemplary embodiment, as well as their various elements, may be made of any material suitable for its respective piping application. For example, exemplary pipe fittings may be constructed of one or more materials, including plastics, metals, ceramics, composites, and other known or later developed materials. Exemplary materials of construction include polyvinyl chloride (PVC), cast iron, and ductile iron. It will be understood by one of ordinary skill in the art how to evaluate the intended use of the piping system and select one or more materials suitable for the construction of the pipe fitting.

Referring to FIG. 1A, a pipe fitting 100 according to an exemplary embodiment may include a first end 104, a second end 106, a body 102 extending between the first end 104 and second end 106. Generally speaking, the pipe fitting 100 is configured to enable the coupling of two or more elements of a piping system. For example, the first end 104 and second end 106 each may be adapted to operably couple with a free end of a pipe. In various embodiments, pipe fitting 100 may have one or more openings or branches (not shown), each adapted to operably couple with other elements of a piping system, enabling the pipe fitting 100 to couple additional elements of a piping system. For example, pipe fitting 100 may have one or more branches extending from the body 102 to form a tee, a cross, or other branched fitting.

Referring to FIGS. 1A-1C, pipe fitting 100 may have a body 102 extending between the first end 104 and second end 106. The body 102 may be straight or it may be at least partially curved or angled. The openings of the first end 104 and the second end 106 may lie in parallel planes. Alternatively, the openings of the first end 104 and the second end 106 may lie in different planes, forming an angle between the first end 104 and the second end 106. The angular relationship may be such that a fluid path through the pipe fitting from the first end 104 to the second end 106 follows a curved path. For example, with reference to FIGS. 1B, 2B, and 3B, in various exemplary embodiments, the pipe fitting 100, 200, or 300 may generally have up to about a 90-degree angle between the openings of the first end 104 and the second end 106.

In various exemplary embodiments, the body 102 may have a circular cross-section. While the exemplary embodiments generally may be described herein with respect to pipes having a circular cross-section, it is understood that the cross-section of body 102 may have other suitable shapes, such as, for example, a square or rectangular cross-section. In various exemplary embodiments, the first end 104 and the second end 106 may have a cross-sectional shape that is similar to the body 102, but it will be understood that each portion of pipe fitting 100 may have a different cross-sectional shape.

In exemplary embodiments, the body 102 of pipe fitting 100 may have an inner diameter, an outer diameter, and a wall thickness. The inner diameter of the body 102 preferably is always equal to or greater than the inner diameter of the adjacent pipes, so that the pipe fitting 100 will not restrict fluid flow within the piping system. The body 102 may be configured so that its wall thickness provides sufficient structural integrity to the pipe fitting 100. One having ordinary skill in the art would understand how to specify the wall thickness for a pipe fitting, factoring in certain variables including material of construction, and intended application of the piping system. The outer diameter of the body 102 is equal to the inner diameter plus twice the wall thickness (to account for each side of the pipe).

In various embodiments, the first end 104 may be configured different from the body 102 so that the first end 104 may be operably coupled with the end of a pipe. For example, referring now to FIG. 1A, the first end 104 may include a hub portion 124 and an enlarged end portion 112. The hub portion 124 may have an inner diameter slightly greater than that of the body 102 of the pipe fitting. For example, the inner diameter of hub portion 124 may be large enough to accommodate the free end of a pipe inserted therein. The enlarged end portion 112 may have an inner diameter that is greater than the inner diameters of body 102 and hub portion 124, respectively. For example, the inner diameter of enlarged end portion 112 may be large enough to accommodate a pipe and a gasket. In exemplary embodiments, the wall thickness of the hub portion 124 and enlarged end portion 112 may be sufficient to provide structural integrity to the pipe fitting, when operably coupled with a pipe end. One having ordinary skill in the art will understand how to configure the wall thickness for the purposes described herein. In an exemplary embodiment, the pipe fitting 100 may be operably coupled with a pipe end such that the pipe end is inserted into first end 104 and is disposed within hub 124, and a gasket (not shown) forms a seal between the pipe and the enlarged end portion 112. In an exemplary embodiment, second end 106 may be configured similar to first end 104. However, it will be understood that first end 104 and second end 106 may have different configurations to accommodate different types of pipes or piping system devices.

In exemplary embodiments, the first end 104 and the second end 106 may be be provided with a coupling mechanism that mates with a corresponding coupling mechanism on the free end of a corresponding pipe. The coupling mechanism may, for example, provide a friction fit, such that a free end of a pipe is inserted into the opening of either the first end 104 or the second end 106 and the surfaces of the pipe and the pipe fitting 100 engage. In other exemplary embodiments, the coupling mechanism may be a threaded coupling, in which first end 104 or the second end 106 may have a threaded surface, and the free end of the pipe has a corresponding threaded surface enabling the pipe fitting 100 and the pipe to operably couple. It will be understood that other coupling mechanisms and devices may be provided to operably couple the pipe fitting 100 with a pipe. The various coupling mechanisms will be understood by one familiar with piping systems. It will be appreciated that the first end 104 and the second end 106 each may be configured with the same or different coupling mechanisms.

In an exemplary embodiment, a gasket may be provided between the surfaces of the first end 104 the second end 106 and the corresponding pipe, to provide a fluid tight seal and a compression fit between the pipe fitting 100 and the pipe. For example, a gasket may be disposed within the enlarged end portion 112 of the first pipe end 104, to provide a compression seal between the enlarged end portion 112 and the outer surface of a pipe received therein. Various suitable gasketing materials will be understood by one familiar with piping systems. For example, an exemplary gasket may be made of rubber, silicon, or plastic, or other suitable material as may be known in the art.

In an exemplary embodiment, the pipe fitting 100 may be configured to be operably coupled with another pipe fitting. For example, referring now to FIG. 1D, another pipe fitting 100B may have a second end 106B, configured more like the end of a pipe, so that pipe fitting 100B may be coupled with pipe fitting 100. In exemplary embodiments, second end 106B may include coupling portion 130, which is shaped similar to a pipe end. The coupling portion 130 is configured to be inserted into a pipe fitting, such as into first end 104 of pipe fitting 100. The second end 106B also may include one or more features to improve the coupling of pipe fitting 100B with other pipe fittings. For example, the second end 106B may have a tapered distal end that eases insertion of end into another pipe fitting; or the second end 106B may have an annular ridge or flange 132 proximal to the end 106B, to act as a guide or stop, or to improve the seal between the two coupled fittings. One familiar with pipe fittings would understand how to design these and similar features.

Referring again to FIGS. 1A-1C, in exemplary embodiments pipe fitting 100 may have one or more projections or tabs such as tabs 108a and 108b (collectively referred to as tabs 108) extending from the outer surface of the pipe fitting 100. The tabs 108 may extend in radial direction from the central axis of the pipe fitting 100, protruding from the outer surface by a radial height 114. In exemplary embodiments, the tabs 108 may be located on the outer surface of the hub portion 124. In exemplary embodiments, the tabs 108 are configured to have a size and shape to provide one or more leverage points to assist in assembly, manipulation, or removal of the pipe fitting 100 in a piping system. For example, tabs 108 may be configured with a predetermined profile that may transfer an applied force in a predetermined direction, and may withstand exertion of an applied force, such as force from an installation tool, such as a pry bar, without failing.

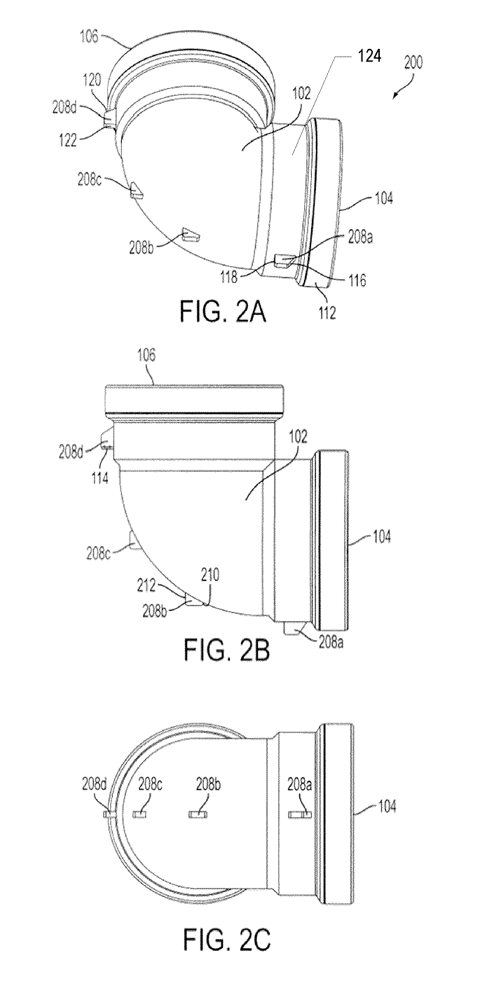

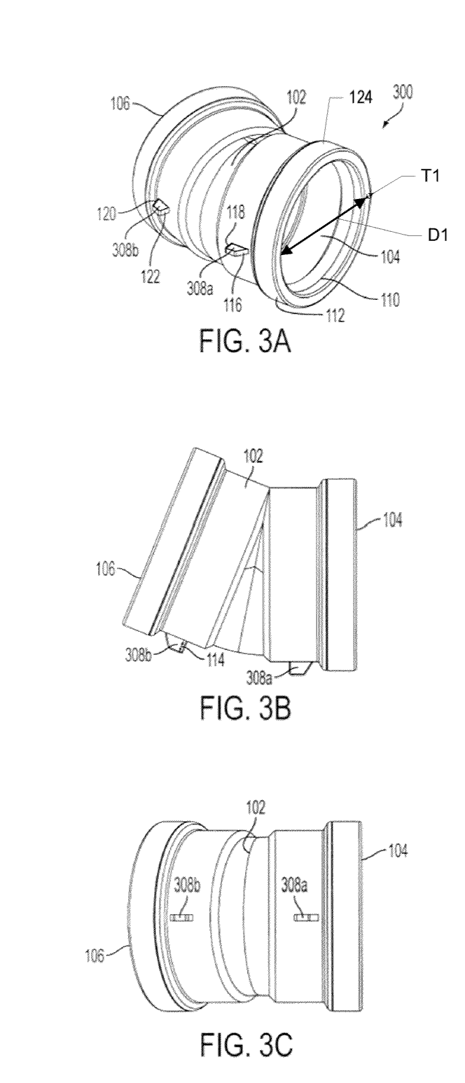

In exemplary embodiments, the one or more tabs 108 may be disposed on the pipe fitting 100 in one or more areas of the pipe fitting 100 that are determined to provide good leverage to assist an installer in positioning and installing the pipe fitting 100. For example, referring to FIGS. 1A-1C pipe fitting 100 may have a first tab 108a disposed proximal to the first end 104 and a second tab 108b disposed proximal to the second end 106 on the hub portion 124. In other exemplary embodiments, pipe fitting 100 may have more tabs or fewer tabs, and tabs located in different positions on the pipe fitting 100. For example, referring now to FIG. 1D, exemplary pipe fitting 100B may have just one tab 108a, disposed proximal to the first end 104. Referring now to FIGS. 2A-2C, another exemplary pipe fitting 200 may have four tabs 208a, 208b, 208c, 208d (collectively referred to as tabs 208), with tabs 208a and 208d disposed near the ends of the pipe fitting 200 on the hub portion 124, and tabs 208b and 208c located more proximally on pipe fitting 200 on the body 102. Referring now to FIGS. 3A-3C, yet another exemplary pipe fitting 300 may have two tabs 308a and 308b (collectively referred to as tabs 308), each disposed near a respective end of pipe fitting 300 on hub portion 124.

In exemplary embodiments, the tabs 108, 208, or 308 may be disposed in a co-linear or co-planar orientation along the outer surface of the respective pipe fitting 100, 200, or 300. For example, referring to FIGS. 1A-1C, the tabs 108a and 108b may be oriented along the same plane on the outer surface of the hub portion 124 of the pipe fitting 100, such as, for example, along a plane bisecting the outer surface of the pipe fitting 100. In alternative embodiments, one or more of the tabs 108a, 108b, (or one or more of 208a, 208b, 208c, or 208d, or one or more of 308a or 308b) may be offset with respect to each other such that the tabs 108a and 108b are located non-colinearly on the outer surface of the pipe fitting 100. It will be appreciated that other such combinations are possible.

In the various exemplary embodiments, the tabs 108, 208, and 308 may be configured to provide a leverage point (or fulcrum) for application of a force to the respective pipe fitting 100, 200, or 300 for the purpose of assembling, manipulating, or removing the pipe fitting 100, 200, or 300 from a piping system. For example, a force may be applied to a surface or edge of a tab with an installation tool, such as a pry bar. Through contact with the tab a force may be transferred from the installation tool to the pipe fitting. The tab may be designed to transfer the applied force from the installation tool to the pipe fitting in a predetermined direction, enabling the manipulation of the pipe fitting so that it may be easily coupled with a corresponding pipe. For example, tabs 108 may be configured so that upon application of force to the tab 108, the pipe fitting 100 moves in a direction perpendicular to the plane of the opening of the pipe fitting. In other exemplary embodiments, the tabs 108 may provide a leverage point that transfers an applied force so that it may rotate the pipe fitting 100, such as to engage the threads of the pipe fitting 100 with the mating threads of the pipe.

In exemplary embodiments, the tabs 108, 208, 308 may be configured to withstand at least a force that is sufficient to operably couple a pipe fitting and corresponding pipe. One familiar with the art and the teachings herein will understand how to configure a tab to withstand such a force.

In exemplary embodiments, the tabs 108, 208, or 308 may have any shape suitable for providing the functions described herein. For example, referring to FIGS. 1A-1C, tabs 108a and 108b may have a fin-like profile projecting from the outer surface of the respective pipe fitting 100, 200, or 300. The shape of the fin-like profile may be configured to have one or more side edges that provide leverage points for the application of force to the pipe fitting 100, 200, or 300. Referring to FIGS. 1A and 1B, in one exemplary embodiment, tab 108a may have a rectangular or trapezoidal profile with a base edge 115 joining the tab 108a and the outer surface of the pipe fitting 100, a first edge 116 and a second edge 118 extending outward from the base edge 115, and an outer edge 117 joining and extending between first edge 116 and second edge 118. The first edge 116 and second edge 118 may be configured to provide leverage points for the pipe fitting 100. The first edge 116 may extend in a plane that is orthogonal to base edge 115, or it may form a different angle. Likewise, the second edge 118 may extend in a plane that is orthogonal to base edge 115, or it may form a different angle thereto. For example, referring now to FIG. 1E, second edge 118 may be disposed at an angle A to base edge 115. In exemplary embodiments, the angle A may be less than 90 degrees. The angle of the tab 108 may be desired to be such that the tab 108 provides a point for application of a force from the installation tool, such that the installation tool may rest securely against the tab 108 and/or be cradled between the tab 108 and hub portion 124 to prevent slippage of the installation tool. It should be appreciated that certain angles and tab configurations may provide a better leverage point than others. For example, certain angles may cause the installation tool to slip off during application.

In exemplary embodiments, the shape and location of tabs 108 may be configured to provide optimal leverage for the pipe fitting 100. For example, the first edge 116 and the second edge 118 of tab 108a may be configured to have an angle that will transfer an applied force in a predetermined direction. Without intending to be bound by any particular theory, it is generally believed that when a force is applied to the surface of first edge 116 or second edge 118, the force is translated to a force on the entire pipe fitting 100 in a direction orthogonal to this respective edge. In exemplary embodiments, the first edge 116 may extend in a plane parallel to the plane of the opening of second end 106, so that application of a force to the first edge 116 may result in a force on the entire pipe fitting 100 in a direction generally orthogonal to the plane of second end 106. In exemplary embodiments, the second edge 118 may extend in a plane parallel to the plane of the opening of the first end 104, so that application of a force to the second edge 118, may result in a force on the entire pipe fitting 100 in a direction generally orthogonal to the plane of the first end 104. It will be understood that the first edge 116 and second edge 118 may be configured to have different angles to transfer the applied force in other advantageous manners. It will be understood that tabs 108, 208, 308 may have other edges or surfaces having the same or similar features and functionality.

Referring to FIGS. 1A-1C, in exemplary embodiments, tab 108b located adjacent second end 106 may have a similar profile to the tab 108a, however the geometry of the edges may be reversed. For example, referring to FIG. 1A, tab 108b may have a first edge 120 and a second edge 122 proximal to first edge 120. In exemplary embodiments, first edge 120 may extend in a direction parallel to the plane of first end 104. In other embodiments, second edge 122 may extend in a direction parallel to the plane of second end 106. It will be understood that tab 108b may have a very different geometry from tab 108a.

In other exemplary embodiments, one or more of tabs 108, 208, 308 may have a triangular shape. For example, referring now to FIG. 2B, in an exemplary embodiment, tabs 208b and 208c may have a triangular shape with a first edge 210 and a second edge 212. The angles of the first edge 210 and second edge 212 may be configured to translate applied forces in a predetermined direction (e.g., orthogonal to the plane of the respective edge) to enable assembly, manipulation, or removal of the pipe fitting 200. It will be appreciated that tabs 108, 208, 308 may have other shapes suitable for providing leverage points for pipe fitting 100.

In exemplary embodiments, pipe fittings 100, 200, or 300 may have tabs 108, 208, 308 in which all have substantially the same shape. For example, referring to FIG. 1B, tabs 108a and 108b may have the same trapezoidal shape (although mirror images of each other). In some embodiments, one or more tabs may have an different shape. For example, referring to FIG. 2B, in an exemplary embodiment, tabs 208a and 208b, disposed adjacent the first end 104 and the second end 106, may have a first shape (trapezoidal), and tabs 208b and 208c may have a second shape (triangular).

In exemplary embodiments, the tabs 108, 208, 308 may be disposed in predetermined regions to provide optimal leverage for respective pipe fitting 100, 200, 300. Without intending to be bound by a particular theory, it is believed that tabs 108, 208, 308 disposed closer to the centerline of an opening will provide a better leverage point for applying force to the respective pipe fitting 100, 200, 300 to move it in the direction of the opening. It also is believed that tabs 108, 208, 308 that are located closer to an opening will provide better leverage for applying a bracing force to the respective pipe fitting 100, 200, 300. For example, referring now to FIGS. 1A-1B, edge 120 and edge 118 both extend generally parallel to the opening at first end 104, and will transfer an applied force in a direction orthogonal to that opening. The tab 108B, however, is closer to the centerline (labeled CL) of the opening at first end 104, and may provide a better leverage point for applying force to the pipe fitting 100 to manipulate it in the direction of first end 104. In comparison, the tab 108a is closer to the opening at first end 104, and may provide a better leverage point for applying force to brace the fitting, such as to resist the force of a pipe being inserted into first end 104.

In other exemplary embodiments, pipe fitting 100 may have a depression (not shown) located on or adjacent to one or more tabs 108. The depression may be configured and dimensioned to conform to the shape of an installation tool. The depression may provide a recess within which an installation tool may rest during application of force to the tab 108. The depression may serve to temporarily secure the installation tool in a predetermined position relative to the tab 108. The depression may be molded or machined into the tab 108. Alternatively, the depression may be molded or machined into the pipe fitting 100 adjacent the tab 108, so long as it does not reduce the wall thickness of the pipe fitting.

In exemplary embodiments, the dimensions of the tabs 108, 208, 308 may vary depending on the configuration of the piping system. For example, a larger pipe fitting 100, 200, or 300, may require more force to manipulate the fitting, and may require a larger tab 108, 208, 308 to accommodate the larger force without breaking. It will be appreciated that tab breakage during installation of the pipe fitting 100 may not be desirable. In some embodiments, the size of tabs 108, 208, or 308 may be configured relative to an installation tool that provides the applied force. For example, the radial height 114 may be at least one-half of the width of an installation tool. Such a height may be desirable to prevent slippage or rotation of the installation tool during application. In exemplary embodiments, the tabs 108, 208, 308 may be of sufficient cross section to withstand the application of force from the installation tool. For example, the tab 108 cross section may be determined based on distance from the inner surface 110 to the outer surface.

Referring to FIGS. 1A-1F, in an exemplary embodiment, pipe fitting 100 may be a 4-inch diameter pipe fitting having two tabs 108a and 108b, each having the same shape and size. In an exemplary embodiment, the tabs 108a and 108b may have a radial height 114 of from about 0.50 to about 0.75 inches, more preferably about 0.71 inches. In an exemplary embodiment, each tab 108a and 108b may have a length L (the length of the outer edge 117) of about 0.70 inches to about 0.90 inches, more preferably about 0.80 inches. In an exemplary embodiment, each tab 108a and 108b may have a thickness T2 of about 0.150 inches to about 0.170 inches, more preferably 0.160 inches. The thickness T2 may vary with the size of the pipe fitting 100. The thickness T2 may roughly correspond with the wall thickness of the body 102. It is understood that these dimensions are exemplary only and are provided for illustrative purposes only. The dimensions are not meant to constrain or confine embodiments of the present inventions.

Referring now to FIG. 1F, in exemplary embodiments, the tabs 108, 208, 308 may be molded into an I-beam type cross-section having a body portion 134 and flange 136. The flange 136 may have a wider cross-section than that of the body portion 134, providing additional strength. The flange 136 may have radiused edges or square edges.

In exemplary embodiments, the tabs 108, 208, 308 may be integral with the respective pipe fitting 100, 200, 300. For example, the tabs 108, 208, 308 may be molded as part of the respective pipe fitting 100, 200, 300, such as during casting. In other exemplary embodiments, the tabs 108, 208, 308 may be formed separately and then joined with or attached to the respective pipe fitting 100, 200, 300.

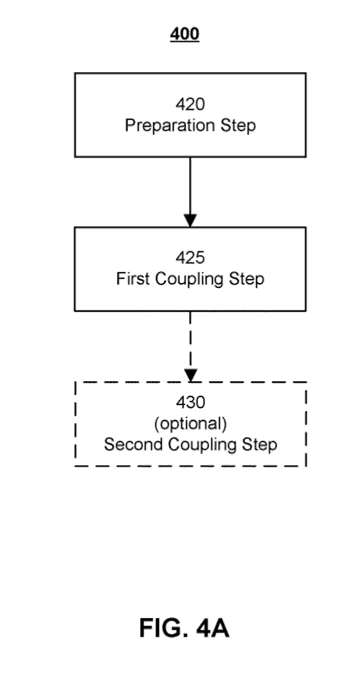

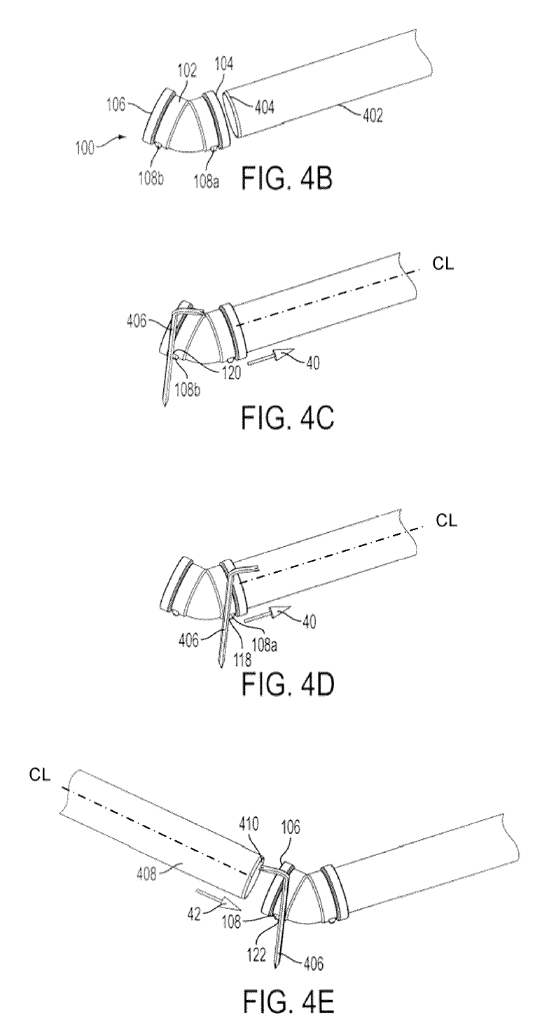

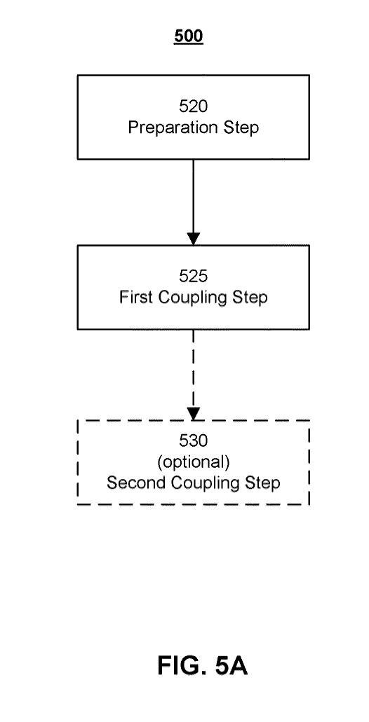

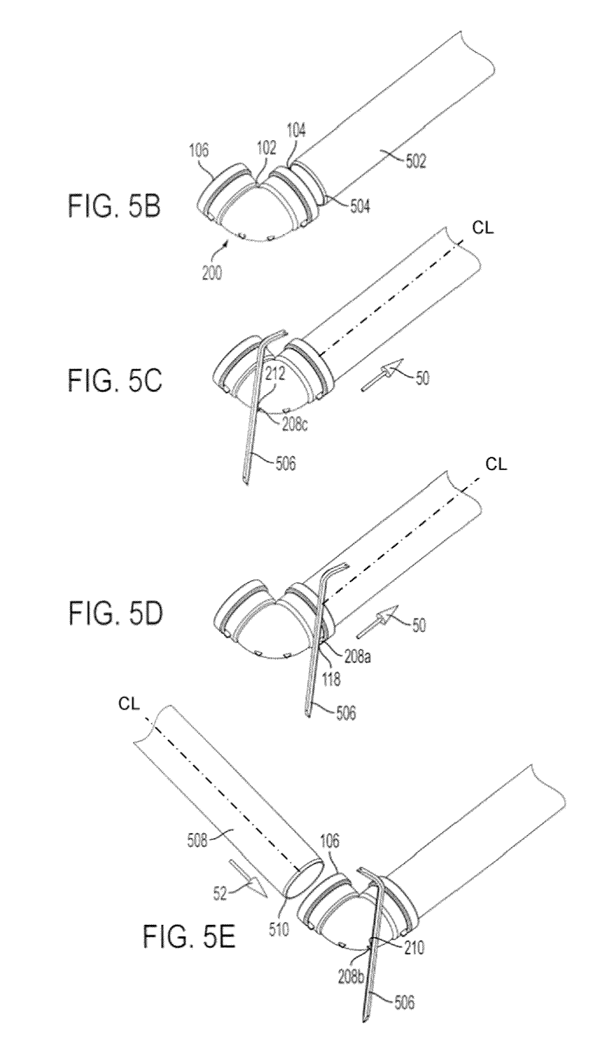

Various exemplary methods will be explained in reference to the embodiments illustrated in FIGS. 4A-5E. It will be understood that these exemplary embodiments are provided by way of example, as there are a variety of ways to carry out the methods disclosed herein. The methods of the embodiments may be executed or otherwise performed by one or a combination of tools and components.

Referring now to FIG. 4A, an exemplary method 400 includes a preparation step 420 in which a pipe fitting and one or more pipes are provided, a first coupling step 425 in which a pipe may be operably coupled to an end of the pipe fitting, and, optionally, a second coupling step 430 in which a second pipe may be operably coupled with the pipe fitting. It will be understood in the diagram in FIG. 4A, the steps of exemplary method 400 are illustrated by a flow chart having blocks representing each step. While FIG. 4A illustrates an exemplary method 400 in which the steps are performed in a particular order, it will be understood that the embodiments of the present invention may be practiced by adding one or more steps to the processes, omitting steps within the processes and/or altering the order in which one or more steps are performed. Each of these steps, and their alternatives, will be described in greater detail below. It should be appreciated that the method described may be applied to existing piping systems and new construction piping systems.

In an exemplary embodiment, the preparation step 420 of method 400 may include providing a pipe fitting having one or more tabs, providing one or more pipes, preparing the pipe fitting and/or one or more pipes for coupling, or any combination of the foregoing steps. For example, referring now to FIG. 4B, a pipe 402 may have a free end 404 with which a pipe fitting 100 may be coupled. The pipe fitting 100 may be sized such that the first end 104 may mate with the free end 404 of the pipe 402. It will be appreciated that the preparation of the pipe or the pipe fitting for connection may involve certain preparation steps as may be known in the art to ensure a fluid tight and structurally sound fit between the pipe and pipe fitting. For example, the free end 404 of the pipe 402 or the first end 104 may be cleaned of dirt and debris, excess length may be cut from the free end 404, lubricant may be applied to the gasket, etc.

In the first coupling step 425 of exemplary method 400, a pipe fitting may be coupled with one of the pipes prepared in the first step 420. For example, referring now to FIGS. 4C and 4D, in coupling step 425, pipe 402 may be coupled with pipe fitting 100, such as at first pipe end 104. The coupling step 425 may involve manipulating the pipe fitting 100 so that first end 104 may be operably coupled with the free end 404 of pipe 402. For example, the pipe fitting 100 may be manipulated to force first end 104 onto the pipe end 404; or the pipe fitting 100 may be braced while pipe 402 is forced into the first end 104 of the pipe fitting 100. In exemplary embodiments, the manipulation may be performed or assisted using an installation tool 406. The installation tool 406 may be any tool suitable for applying pressure to the pipe fitting 100, such as, for example, a pry bar. In an exemplary embodiment, the installation tool 406 may apply force to one or more of the tabs 108, to provide a force sufficient to operably couple the pipe fitting 100 with pipe end 404. In exemplary embodiments, the tabs 108 may provide leverage points by which the installation tool 406 may exert a force onto the pipe fitting 100 to manipulate and operably couple the pipe fitting 100 onto the end 404 of the pipe 402. For example, referring now to FIG. 4C, the installation tool 406 may apply force to the first edge 120 the edge of tab 108b. The edge 120 may be configured to translate the force on the tab 108b into a force on the pipe fitting 100 in the direction indicated by arrow 40, to provide an assembly force on the pipe fitting 100. In preferred exemplary embodiments, the first edge 120 of the tab 108b may provide a force vector that may be close to the centerline CL of the first end 104. Referring now to FIG. 4D, in other exemplary embodiments, the installation tool 406 may be used to apply force to the second edge 118 of tab 108a. The second edge 118 may be configured to translate the force on the tab 108a into a force on the pipe fitting 100 in the direction indicated by arrow 40. This leverage point may be more advantageous for providing a bracing force, i.e., a force used to hold the pipe fitting 100 in position while the pipe 402 is brought into contact with the pipe fitting. In the coupling step 425, either one or both of tabs 108a and 108b may be used to apply force to pipe fitting 100. As a result of the first coupling step 425, pipe fitting 100 may be operably coupled with pipe 402.

Exemplary method 400 may optionally include a second coupling step 430, in which pipe fitting 100 may be operably coupled with one or more additional pipes. For example, referring now to FIG. 4E, in the second coupling step 430, pipe 408 may be coupled with pipe fitting 100, such as at pipe end 410. The second pipe fitting step 430 may involve manipulating the pipe 408 and bracing the pipe fitting 100 so that pipe end 410 may be operably coupled with the second end 106 of the pipe fitting 100. In an exemplary embodiment, the installation tool 406 may apply force to one or more of the tabs 108, to provide a force sufficient to brace the pipe fitting 100 to operably couple the pipe fitting 100 with pipe end 410. For example, referring now to FIG. 4E, the installation tool 406 may apply force, such as a bracing force, to the second edge 122 the edge of tab 108b. The edge 122 may be configured to translate the applied force on tab 108b into a bracing force on the pipe fitting 100 in the direction counter to the direction indicated by arrow 42. Similarly, the installation tool 406 may be used to apply a force to the first edge 116 of tab 108a. The edge 116 may be configured to translate the applied force on tab 108a into a force on the pipe fitting 100 in the direction counter to the direction indicated by arrow 42. In the second coupling step 430, the installation tool 406 may exert a force on either tab 108a or tab 108b manipulate or brace the pipe fitting 100 while the pipe 408 may be operably coupled with the pipe fitting 100. As a result of the second coupling step 430, the pipe fitting 100 may be operably coupled with pipe 402 and pipe 408.

Referring now to FIG. 5A, another exemplary method 500 includes a preparation step 520 in which a pipe fitting and one or more pipes are provided, a first coupling step 525 in which an end of a first pipe end may be operably coupled with the pipe fitting, and, optionally, a second coupling step 530 in which a second pipe may be operably coupled with the pipe fitting. It will be understood in the diagram in FIG. 5A, the steps of exemplary method 500 are illustrated by a flow chart having blocks representing each step. While FIG. 5A illustrates an exemplary method 500 in which the steps are performed in a particular order, it will be understood that the embodiments of the present invention may be practiced by adding one or more steps to the processes, omitting steps within the processes and/or altering the order in which one or more steps are performed. Each of these steps, and their alternatives, will be described in greater detail below. It should be appreciated that the method described may be applied to existing piping systems and new construction piping systems. It should be appreciated that the method described may be applied to existing piping systems and new construction piping systems.

While the method of FIG. 5A illustrates certain steps performed in a particular order, it should be understood that the embodiments of the present invention may be practiced by adding one or more steps to the processes, omitting steps within the processes and/or altering the order in which one or more steps are performed.

In an exemplary embodiment, the preparation step 520 of method 500 may include providing a pipe fitting having one or more tabs, providing one or more pipes, preparing the pipe fitting and one or more pipes, or any combination of the foregoing steps. For example, referring now to FIG. 5B, a pipe 502 may have a free end 504 to which a pipe fitting 200 may be attached. The pipe fitting 200 may be sized such that the first end 104 may mate with the free end 504 of the pipe 502. It will be appreciated that the preparation of the pipe and the pipe fitting for connection may involve certain preparation steps as may be known in the art, such as cleaning the free end 504 of the pipe 502, cleaning the first end 104, preparation of the pipe 502 and pipe fitting 200 threads (if present), cutting off excess length of the free end 504, application of sealant and/or lubricant, etc.

In the first coupling step 525 of exemplary method 500, a pipe fitting may be coupled with one of the pipes prepared in the first step 520. For example, referring now to FIGS. 5C and 5D, in coupling step 525, pipe 502 may be coupled with pipe fitting 200, such as at first pipe end 104. The coupling step 525 may involve manipulating the pipe fitting 200 so that first pipe end 104 may be operably coupled with the free end 504 of pipe 502. For example, the pipe fitting 200 may be manipulated to force first end 104 onto the pipe end 504; or the pipe fitting 200 may be braced while pipe 502 is forced into the first end 104 of the pipe fitting 200. In exemplary embodiments, the manipulation may be performed or assisted using an installation tool 506. In an exemplary embodiment, the installation tool 506 may apply force to one or more of the tabs 208, to provide a force sufficient to properly manipulate and operably couple the pipe fitting 200 with pipe end 504. The tabs 208 may be configured to provide leverage points by which the installation tool 506 may exert a force onto the pipe fitting 100 to properly manipulate the pipe fitting 200 onto the end 504 of the pipe 502. For example, referring now to FIG. 5C, the installation tool 506 may apply force to the to the second edge 212 of tab 208c. The second edge 212 may be configured to translate the force exerted on the tab 208c into a force on the pipe fitting 200 in the direction indicated by the arrow 50, to provide an assembly force on the pipe fitting 200. In preferred exemplary embodiments, the second edge 212 of the tab 208c may provide a force vector that may be close to the centerline CL of the opening of the first end 104. In another example, referring to FIG. 5D, the installation tool 506 may be used to apply force to the second edge 118 of tab 208a. The configuration of the angle of the second edge 118 may translate the force exerted on the tab 208a into a force on the pipe fitting 200 in the direction indicated by the arrow 50. This leverage point may be more advantageous for providing a bracing force, i.e., a force used to hold the pipe fitting in position while the pipe 502 is brought into contact with the pipe fitting 200. The installation tool 506 may apply force to any edge or surface of any of the tabs 208 that is configured at an angle that will translate the applied force into a force on the pipe fitting 200 in the direction indicated by the arrow 50. In the first coupling step 525, the installation tool 506 may exert a force on any of the tabs 208a, 208b, 208c, 208d, to apply a force to the pipe fitting 200 in the direction indicated by the arrow 50. As a result of the first coupling step 525, pipe fitting 200 may be operably coupled with pipe 502.

Exemplary method 500 may optionally include a second coupling step 530, in which pipe fitting 200 may be operably coupled with one or more additional pipes. For example, referring now to FIG. 5E, in the second coupling step 530, pipe 508 may be coupled with pipe fitting 200, such as at pipe end 510. The second pipe fitting step 530 may involve manipulating the pipe 508 and bracing the pipe fitting 200 so that pipe end 510 may be operably coupled with the second end 106 of the pipe fitting 200. In an exemplary embodiment, the installation tool 506 may apply force to one or more of the tabs 208, to provide a force sufficient to operably couple the pipe fitting 200 with pipe end 510. For example, referring now to FIG. 5E, the installation tool 506 may apply force to the first edge 210 of tab 208b. The first edge 210 may be configured to translate the force exerted on the tab 208b into a bracing force on the pipe fitting 200 counter to the direction indicated by the arrow 52. Likewise, the installation tool 406 may be used to apply force to any edge or surface of any of the tabs 208 that is configured at an angle that will translate the applied force into a force on the pipe fitting 200 counter to the direction indicated by the arrow 52. In the second coupling step 530, the installation tool 506 may exert a force on any or all of the tabs 208 to manipulate or brace the fitting 200 while the pipe 508 is operably coupled with the pipe fitting 200. As a result of the second coupling step 530, the pipe fitting 200 may be operably coupled with pipe 508 and pipe 502.

In the preceding specification, various exemplary embodiments have been described with reference to the accompanying drawings. Other embodiments, uses, and advantages of the present invention will be apparent to those skilled in the art from consideration of the specification and practice of the invention disclosed herein. The specification and examples should be considered exemplary only.

It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An apparatus, comprising:
a pipe fitting comprising a first end and a second end and a body extending therebetween; and
a projection extending radially outward from an exterior surface of the pipe fitting, and having a first leverage portion whereby application of a first applied force to said first leverage portion results in a first translated force on the pipe fitting.

2. The apparatus of claim 1, wherein said first leverage portion is configured so that said first translated force is in the direction of said first end of said pipe fitting.

3. The apparatus of claim 1, wherein said first leverage portion is configured so that said first translated force is in the direction of said second end of said pipe fitting.

4. The apparatus of claim 1, wherein said projection has a second leverage portion whereby application of a second applied force to the second leverage portion results in a second translated force on the pipe fitting.

5. The apparatus of claim 1, wherein said projection comprises a trapezoidal shape, having a first edge along the exterior surface of said pipe fitting; a second edge that is radially spaced from said first edge; and a third edge and a fourth edge extending between and connecting said first edge and said second edge.

6. The apparatus of claim 5, wherein said leverage portion is disposed along said third edge or said fourth edge.

7. The apparatus of claim 1, wherein said projection comprises a triangular shape, having a first edge along the exterior surface of said pipe fitting; a second edge extending from one end of said first edge; and a third edge extending between and connecting said first edge and said second edge.

8. The apparatus of claim 7, wherein said leverage portion is disposed along said second edge or said third edge.

9. The apparatus of claim 1, wherein the apparatus comprises a plurality projections extending radially outward from an exterior surface of the pipe fitting.

10. The apparatus of claim 9, wherein at least two of said plurality of projections have substantially the same shape.

11. The apparatus of claim 9, comprising four projections.

12. The apparatus of claim 11, wherein said four projections are oriented co-linearly or co-planar between said first end and said second end.

13. The apparatus of claim 11, wherein at least two of the four projections differ in structure.

14. The apparatus of claim 1, wherein said pipe fitting has a non-linear configuration from said first end to said second end.

15. The apparatus of claim 1, wherein a gasket is disposed adjacent said first end or said second end.

16. A method, comprising:
providing a pipe fitting having at least a first end, a second end, a body, and at least one radially extending projection with a leverage point;
providing a first pipe;
applying a force to said leverage point of said projection resulting in a force on the pipe fitting in the direction of the first end;
operably coupling said first end of said pipe fitting with said first pipe.

17. The method of claim 16, wherein applying a force to said leverage point comprises applying an installation tool to the leverage point.

18. The method of claim 16, wherein said pipe fitting has at least two radially extending projections with a leverage point.

19. The method of claim 16, wherein said pipe fitting has at least four radially extending projections with a leverage point.

20. The method of claim 16, further comprising:
providing a second pipe;
applying a force to the leverage point of said at least one projection resulting in a bracing force in the direction of the second end;
operably coupling said second end of said pipe fitting with said second pipe.

21. The method of claim 16, wherein the first pipe comprises a pipe fitting.
